(19) United States
(12) Patent Application Publication
(10) Pub. No.: US 2011/0067358 A1
(43) Pub. Date: Mar. 24, 2011

(54) Packing and Presentation of Ice-Cream in the Form of Scoops

(76) Inventors: Kareemullah Shaik, Hyderabad (IN); Faheemullah Shaik, Hyderabad (IN); Fathima Shaheen, Hyderabad (IN)

(21) Appl. No.: 10/595,865

(22) PCT Filed: Nov. 17, 2003
(86) PCT No.: PCT/IN2003/000360

§ 371 Date: Oct. 29, 2007

(51) Int. Cl. B26D 7/27

(52) U.S. Cl. 53/396

(57) ABSTRACT

A method, System and Dressing of ice-cream & Desserts for enhancing the commercial value further by using the compatible container system. Features include the use of a premium container system, that provides an instant step in presenting multi facets of various desserts, which supplement in a area where speedy delivery in a short time is required, with less inventory includes less infrastructure & coordination of equipments which already exists. However, the infrastructure & equipments has limitations without the method, system and compatible container.

### FIELD OF THE INVENTION

The present invention is directed to a system method and dressing of the ice-cream and dessert or such related products from the similar category such as the Dairy, Non Dairy, Frozen ice-cream, Frozen Dessert, Soft serve desserts and the likes. More specifically, the present invention is directed to a system, method and dressing of ice-cream & Desserts as mentioned above for enhancing the commercial viability of the product further. Hence, the end product gain a commercial cutting edge against the already existing process use by the present system in comparison with the latest invention of system and method of dressing the ice-creams and desserts.

### BACKGROUND OF THE INVENTION

Milk products is a natural source of energy for all age groups, better if the fats and calories are in a proportionate low quantity, specially for grown up, but still is regarded as a best source of energy for the body requirements, the same applies to ice-cream and dessert and the likes. It has been enjoyed from centuries and a lot of changes have occurred as of date.

And still everyone looks for more exciting things happened to it, as time goes by and will be well accepted, the present innovation is a combination of all that. However, not without the system and method of dressing on the scoop from the compatible container system. On the other hand it is quick, hygiene, ever fresh maintainable state of product, user friendly even if it is a non-professional (Amateur) person handling it thus give a consistent result all the time, where the scope of acceptance and growth of such parlor are high. Also offer's a reliable accountability. To address this variability issues, even the early pioneers of ice-cream and dessert industries with parlor through out the country could manage a few parlor with great difficulties in each city due to its speculatively less profitability and constant burden of, skilled management staff, storage of huge quantity of flavor of ice creams and dessert in relation to its moment of brisk sales or not, on even wastage and real estate cost.

In comparison to earlier days, today the cold chain exist in a manner, which one can never believe that the end product is reached from manufacture to consumer as fresh as it was produced, thank to all the technological development with which the present system of method & dressing can do wonders to the ice-cream and dessert manufacturing industry and domestic market as well.

A perplexing task that has somewhat stifled the use of different products (i.e. ice-cream, desserts and various dressing) as of date is they were looked upon as parallel products, competing in the same sector for their share of market, by using the innovative systems, method of dressing. It tends to give you the profits & advantages of combined product, also enhancing the commercial value of the products, as of the present innovation.

The method & system of dressing is a combination of two different ice-creams or dessert or similar combination of one dessert & ice-creams together, thus bringing it under one portfolio. In the light of the price of the same product (i.e. product means or represent all types of frozen dessert, frozen ice cream, soft serve and the likes) produced by the existing parlor; to effectively match the costing during peak hour, peak seasons, lean hour, lean season, to effectively make up for the lean hours & lean seasons. As a consequence the product cost, over staffed and high maintenance, during the lean hour sales, the size of the parlor & real estate cost plus the average turnover recorded on a annual basis and high income in season and low income in-off season, the short duration of the summer season and unreliable sales at sometimes even during the seasons has limited the proliferation of such parlors. This is where the present invention fits in the gap and gives a phenomenal business, which is left untapped. Further more, the commercial cost of the end product will be greatly reduced.

With the past and present practice, as a consequence in many instances the parlors declined, some are running on no-loss, no-profit basis, some are run by the company for the sake of their image, and interestingly some parlors turned into fast food joints, making ice-cream and dessert their secondary business.

Nevertheless, being a nation of ice-cream lovers, the volume kept the business in good health of the existing parlor, with the present system.

As recognized by the present invention there are several drawbacks associated with the system adopted by the parlors. First it should be recognized, that at the end of the day the number of scoops scooped should be proportionate, the quantity determined per scoop, (i.e. if it is ‘X’ no. of scoops to a gallon of ice-cream or dessert, the system should reflect the accountability as to how many scoops of different flavor have gone into different types of sundaes served, are you able to track & match your cost as calculated, it also means there has to be continuous balance between the input and output in such a system, hence this is the system that is employed to coordinate the consumption of different flavor of ice-cream & dessert consumed in different sundae's equally.

Also a consistent shape, quantity and quality of product is delivered on a continuous basis.

In the present conventional system, there is a lot of disparity from what you calculate as cost & what you practically get; there is an unseen loss by way of number of scoops effecting your profitability.

Inconsistent portions served every time or the staff should be a thorough professional, sincere to their job all the time, monitoring the count at every stage, should be present all the time to deliver such results of accountability on all count, such an instance is not possible. In some instances, such loss of quantity or pilferage of ice-cream or dessert are considered as an average loss added to the costing and switched over to the customer, raising the retail cost and burdening the customers.

Many parlors or ice-cream joints exist, with the present adopted system, the cost goes up by 3 to 5 times, they do deserve to price their product as such, because they provide with such ambience and facilities as you are enjoying your ice-cream, however they cannot operate in the many locations in the same area, thus making their parlors not commercially viable in many numbers compared to this innovation of more reliable & less costly method, system and infrastructure.

More particularly these days the ice-cream is sold in fancy containers like toys, balls etc., in which the ice-cream is filled and stored for selling where in the end product is a toy left for the children to play.

More elaborate models and varieties of ice cream & soft serve keep coming into the market, to keep up with the competitions. But too many manufacturers with similar products share the market. However similar, they are all accepted. The innovative method deals, with the similar product in an entirely different manner, thus creating an all-together different market.

### Disadvantages

Parlors have their own way of handling the product and making their own sundaes. Generally, the parlor management stocks 10 to 20 varieties of bulk packs (a gallon each) taking a huge space, consumption of power to run the display freezer. The ice cream is scooped out as per order at different intervals, each time the ice cream is scooped with a scooper. Every time there is a change in the staff personnel, each person have their style of scooping fluctuating in size, quantity, effecting the economic of the product price. Due to slight unclean handling, it effects the hygiene of the product sometime or most of the time due to longer exposure of the product to different temperature and moisture, distortion & ice flakes in the product, appearance, also taste difference.

Hence, a fluctuation in number of scoops, hygiene, presentation and taste, at time's inconsistent product delivery.

### New Art

Out of all various ways of ice-cream presentation & sales, the most preferred are exotic Sundaes, whose availability is restricted to only parlors, that too full fledged professionally handled parlor with time limitations and location.

Parlors with sitting Customers have to wait or go back if the parlor is full, sales has a limitations, when there is no rush, the seats are empty but the maintenance remains the same.

Take away counters, customers drive in pick up all their choices of stuff and drive away. Phenomenal unseen business, without limitations or volume sales, minimum customer demands, the counter can be open as per peak hour timings only, if suitable.

Hence, new opportunities and growth exists. Immense potential can be explored by innovation, keeping in mind the local food habits and tastes.

It deals with the same products in a different manner. The ice-cream is not in bulks, accountable in numbers, less handling, consistent in shape & quantity, completely hygiene. Taking less space in the parlors, less power.

The innovation has more compatibility can be portable, can be installed any where with lowest expense and the product can be delivered in very short time comparatively can be made by a Amateur and served instantly.

Dessert can be made and served at any corner shop, mall, resort, hotels with minimum space, inventory and can be served to maximum number of customers, more varieties in minimum time with less professional handling staff like (Dessert making master).

With special dispensing cabinets for commercial market, special concept of this method for domestic market, this area of segment can experience a phenomenal acceptability and success.

### ADVANTAGES

System, Method & Dressing of ice cream & dessert produced for enhancing the commercial value and extending its compatibility in maximum area where its potential is present, a part of the ingredient produced in a unique shape suitable to produce the same appearance of the ice-cream and dessert available.

Hence, the important think is the way it is assembled and produced to its original appearance, with less time and lesser professional staff, at a lower cost.

### OBJECTIVES OF THE INVENTION

The present description of the invention is not intended to be limited to the discussion in the following few paragraphs in this section, but rather is a synopsis of selected facets of the present invention. For a more complete understanding of the present invention should be construed in the light of this entire document. Nevertheless, an object of the present invention is to address the above identified and other shortcomings of conventional system Vs Compatible Container Technology.

Another feature of the present invention is to provide a system, method and dressing of the ice-cream & desserts, and the like, is to convert the already premium product in power product (i.e. a Power product giving the extra revenue power to the manufacturer, the dealer and most importantly the extra buying power to the consumer for its comparative cost difference).

Another feature of the present invention is to provide a system, method & dressing of the products is to bring various ice-creams, dessert soft serves and the like under one portfolio giving more revenue & low cost production.

Another feature of the present invention is it delivers consistent quality, quantity, shape, smoothness and taste in the sundaes, dessert and the likes all the time.

Another feature of the present invention is, it acts as a walking parlor, which is low costing can be moved into any odd place at odd times to deliver its performance during single day concerts, meetings, carnivals or crowded places.

Another feature of this invention is considering the complete infrastructural cost it is economically viable to run only during the peak hours and close in during the rest of the lean hours, like commercial office areas busy during the lunch & evening hours, the parks and crowded during the evening hour, hence all the other costs, you save by not operating during the lean hours. You are also saving on the “Manpower”, also the lean hour costs are not eating into your peak hour profits.

Another feature of this invention is it proliferates such parlor on wheels selling premium sundaes like the “Hot dog” Vendors all over the potential areas.

Another feature of this invention is that, since the sales potential of ice-cream and the likes hugely varies from different season and also unexpected bad weather which may vary daily & seasonally, come what may this present innovation, system & method is both reliable in terms of short variation, long term reliability, as well as during peak hours.

Another feature of this invention is, that how it enables to make a sundae at home, much quicker and easier, thus a potential product to penetrate into the domestic market to cater to personal party, birthday and the likes.

Another feature of this invention is it involves low cost production, hence the end product reaches the customer proportionately low cost price giving the customer all the benefits at the same time good profit to the dealer, and to the manufacture the best returns and an product profile.

Another feature of the invention is to have a Kiosk concept for the method enabling self employed entrepreneurs to start their business opportunity with low investment by which further scope for employment is generated.

### DESCRIPTION OF THE DRAWINGS

A more complete appreciation of the invention and many of the attendant advantages thereof will be readily obtained as the same becomes better understand by reference to the following detailed description when considered in connection with the accompanying drawings.

More elaborate designs have been developed to make ice creams and desserts more competitive with other type of ice creams and the likes in the market; once again the system is based on the containers used in Figures.

According to, the attached FIG. 1 is the single scoop packed in a peelable container with outer packing of box. 2 is the peelable scoop container. 3 is the product filling area. 4 is the female outer cover. 5 is the male container holding scoop. 6 is showing top inlet to fill the product in the container. 7 is variable of scoop surface designs proposed. 8 is tray to hold multiples of scoop product. 9 is product holding area. 10 is product filling area. 11 is side view of a tray holding multiple scoop. 12 is one of the lid packing of the variables. 13 is peelable scoop container with variable of perforation. 14 is peelable scoop holding container surface. 15 is one of the view of a peelable container with product exposed. 16 is scoop ready to use prepared in a container. 17 is frozen scoop topped with soft serve dessert. 18 is container holding the entire product ready to be serve. 19 is female contain of more than one scoop, also acts as a serving container disposable. 20 is scoop products to hold more than one scoop. 21 is peelable male container strong enough to hold more than one scoop. 22 is one of the variable of spacer to penetrate inside the product to create a internal pressure & external surface design as per the surface container design. 23 is container to allow a different shape when spacer is inserted. 24 is complete container showing product with spacer. 25 is one of the variable of external design created when the spacer is completely inserted. 26 is variable of spacer inserted in a container to create a semi-scoop. 27 is surface showing a semi-scoop shape created due to inserting a spacer. 28 is downwards pressure of the spacer. 29 is the arrow showing the upward pressure of the product lifting upwards due to the spacer downward pressure.

FIG. 1: shows the packing of the single scoop in packed form with outer packing box.

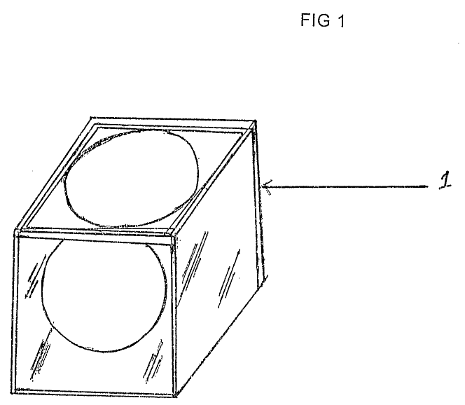

FIG. 2: shows the packing of the single scoop when the packing is separated into outer container and inner container.

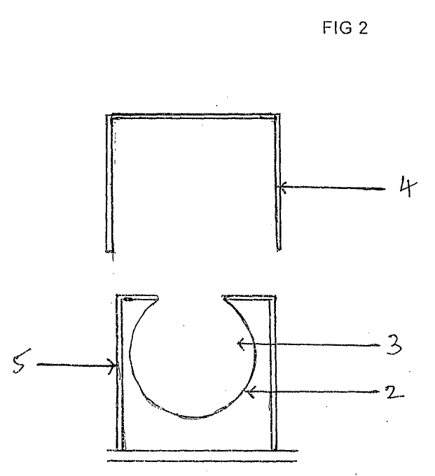

FIG. 3: shows the over view of the inner packing area which shows the product filling area.

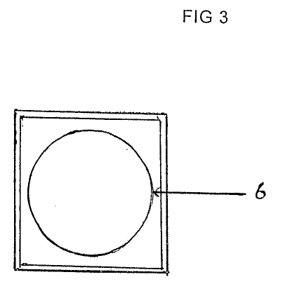

FIG. 4: shows the transverse section of the inner packing area with product filling area, which shows a different inner scoop surface.

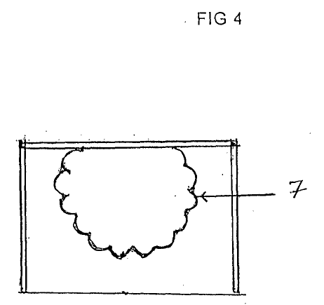

FIG. 5: shows the inner container holding the space for multiple scoops showing the product filling and holding area.

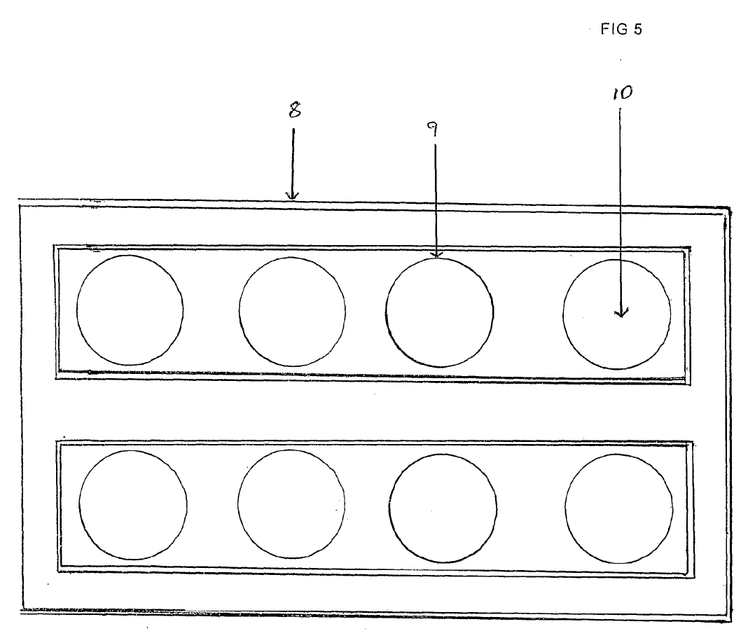

FIG. 6: shows the side view or transverse view of the packing with outer and inner containers holding multiple scoops.

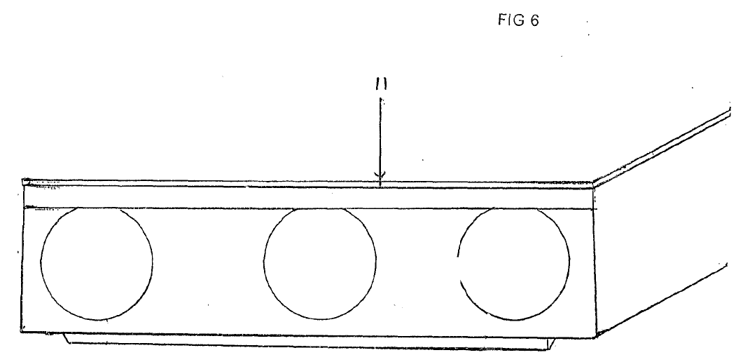

FIG. 7: shows the inner packing of the single scoop with outer peelable area, which is made of with or without perforated peelable cover.

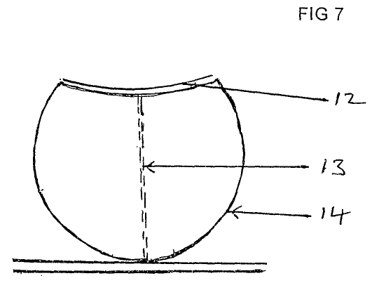

FIG. 8: shows the view of a peeled container with product exposed.

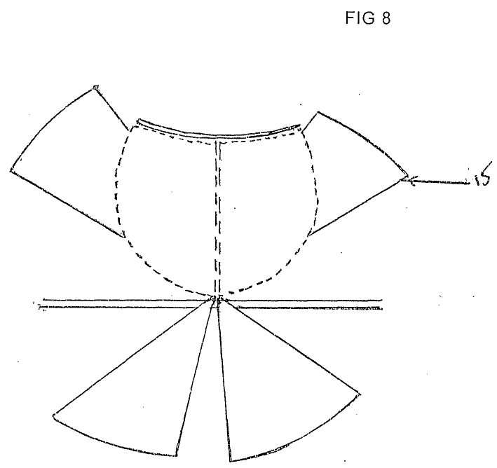

FIG. 9: shows the container holding the entire product ready to be served.

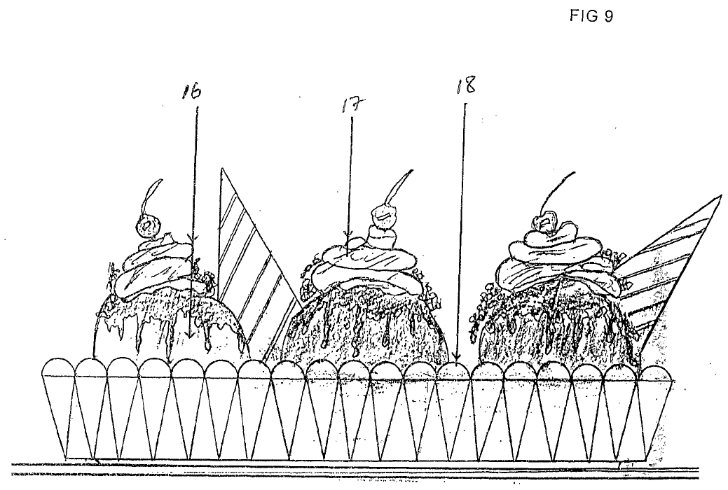

FIG. 10: shows the outer container of more than one scoop, which also acts as a disposable serving container.

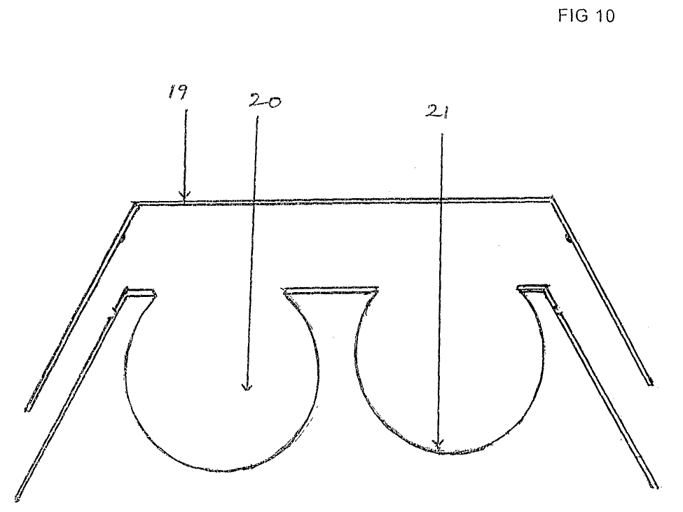

FIG. 11: shows one of the variables of spacer to penetrate inside the product to create a internal pressure and external surface design.

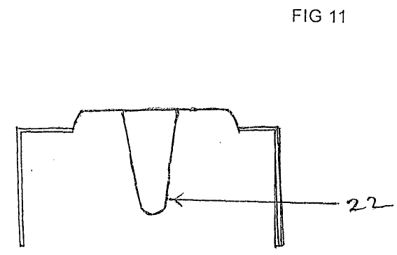

FIG. 12: shows the inner container to allow a different shape when spacer inserted.

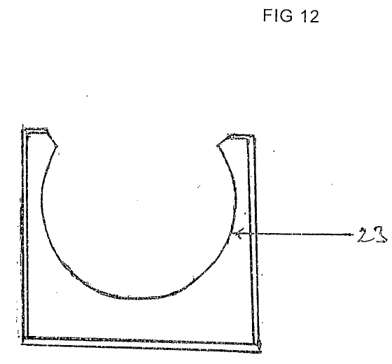

FIG. 13: shows the complete container with spacer inserted.

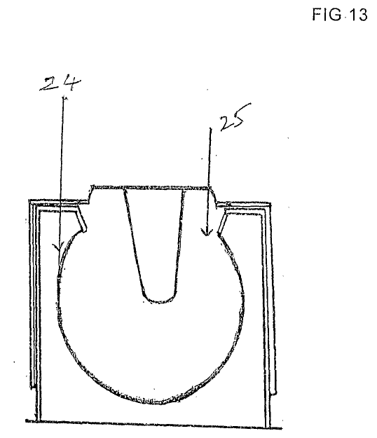

FIG. 14: shows one of the variables of external design created when the spacer is completely inserted.

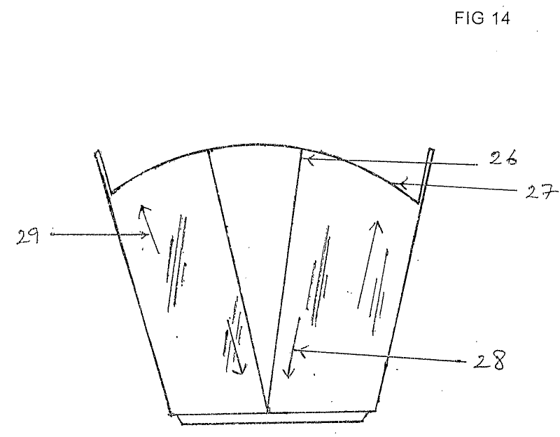

### DETAILED DESCRIPTION

The description of the invention includes the method of packing & presentation of the ice cream & desserts. As discussed extensively in the background and the objectives of the invention, the invention relates to a novel packing & presentation of the ice cream & dessert, which makes the preparation easier and simpler.

The packing of the scoop has two containers (4 & 5), one is the inner container (5) or also called the male container and the other is outer container (4) or also called female container.

The outer cover (4) placed on the inner container (5) for closing of the products. The outer container (4) is a hard container, which is used as the serving container (18) for the products or scoops. When the products in the inner container (5) are placed in the outer container (4 or 19) by reversing the inner container into the outer container. Necessary topping (17) is done in this container and looks like a bowl or acts like a container for the scoops or the products for serving.

The inner container is peelable (13) having the space for the product to be filled in the container. When the outer container (4) is removed to consume the scoops or product the skin of the container is peeled off along the perforated grooves or without the perforated grooves (13) by which the product in the form of scoop is exposed. The exposed scoops or product is placed in the outer container by reversing the inner container by which the product in the shape of the scoops is placed in the outer container for consumption.

Thus placed product is topped with the necessary nut, soft serve and fruits for decorative appearance and is consumed. The shape of the scoops that are placed in the outer container depends upon the inner container shape (7) as shown in the figures.

Further to get more flavored scoops with inner placed dry fruits or gel or other products, a spacer (22) is inserted into the space provided for the product. The spacer (22) which is attached to the outer cover is placed when the product is filled in the inner container. When this spacer is inserted (25) by pacing the outer container, the spacer (25) pierces into the product by downward pressure (28) by which creating an upward pressure (29) in the product by which a semi scoop (27) is formed on the top.

We claim:

1. The method of packing and presentation of ice-cream, desserts and the likes in the form of scoops.

2. According to claim 1, the packing contains two containers one outer and another inner.

3. According to claim 2, the inner container holds the product in the form of the scoop.

4. According to claim 2, the inner container is peelable, which can be peeled off to expose the product for consumption.

5. According to claim 2, the outer container serves as the serving container for the ice cream or dessert.

6. According to claim 3, the design of the scoop depends upon the inner shape provided to the inner surface of the inner container.

7. According to claim 1, the product is served in the outer container in which the shape of the scoops is rested into the actual shape by inversion of the products or inner container.

8. According to claim 1, where in the soft serve enables the scoop presentable in the method of dressing as described.

9. According to claims 1 to 5 the outer container has the spacer fixed inside the outer container.

10. According to claim 9 the spacer is inserted into the inner container by which the product in the inner container is pressed upwards to give a semi scooped shape or any other shape that the outer container has.
